(19) United States
(12) Patent Application Publication
(10) Pub. No.: US 2025/0373999 A1
(43) Pub. Date: Dec. 4, 2025

(54) PROXIMITY-BASED SPEAKER GROUPING AND CONTROL

(71) Applicant: Bose Corporation, Framingham, MA (US)

(72) Inventors: Thomas David Chambers, Bellingham, MA (US); Lauren Taylor Westendorf, Waltham, MA (US); Mika Ichiki-Welches, Somerville, MA (US); Cameron Edward Hudson, Waltham, MA (US); David Edwards Blore, Southborough, MA (US)

(21) Appl. No.: 18/731,937

(22) Filed: Jun. 3, 2024

(51) Int. Cl. H04S 7/00

(52) U.S. Cl. CPC H04S 7/302

(57) ABSTRACT

Various implementations include speakers and approaches for grouping speakers. In some cases, a method includes, determining a location of a speaker relative to one or more other speakers; and in response to a change in the location of the speaker relative to the one or more other speakers, dynamically modifying audio playback of at least one of the speaker or the one or more other speakers such that the modifying of the audio playback continually occurs while the change in the location of the speaker occurs.

### TECHNICAL FIELD

This disclosure generally relates to audio systems. More particularly, the disclosure relates to controlling acoustic properties of an audio device based on a device identifier.

### BACKGROUND

Portable speakers such as portable home speakers can enable convenient, spontaneous creation of audio environments in many usage scenarios. However, conventional portable speakers can have shortcomings, particularly in terms of coordinating output with additional speakers in a group. For example, adding or removing portable speakers from a speaker group can be cumbersome and/or cause undesired output among speakers in the group. Additionally, creating roles for speakers in a group can be complex and cumbersome, particularly when one or more speakers in a group is portable.

### SUMMARY

All examples and features mentioned below can be combined in any technically possible way.

Various implementations include speakers and approaches for grouping speakers. In some cases, a method includes, determining a location of a speaker relative to one or more other speakers; and in response to a change in the location of the speaker relative to the one or more other speakers, dynamically modifying audio playback of at least one of the speaker or the one or more other speakers such that the modifying of the audio playback continually occurs while the change in the location of the speaker occurs.

In additional particular aspects, a speaker includes: an electro-acoustic transducer; and a processor coupled with the electro-acoustic transducer, the processor programmed to: determine a location of the speaker relative to one or more other speakers; and in response to a change in the location of the speaker relative to the one or more other speakers, provide instructions to dynamically modify audio playback of at least one of the speaker or the one or more other speakers such that the modifying of the audio playback continually occurs while the change in the location of the speaker occurs.

Implementations may include one of the following features, or any combination thereof.

In some cases, the modified audio playback is initiated in response to detecting a change in the speaker location, which can be at a power cycle, startup or initial setup phase. In certain aspects, the audio playback is modified at a first instance of audio output by the speaker after detecting the change in speaker location.

In particular aspects, the audio playback includes at least one audio playback property (or, “acoustic property”) including, audio content, output volume, output directionality, output spatialization, frequency response, portions of an audio signal, channel assignment of an audio signal in a stereo configuration (e.g., Left or Right, multichannel, or derived multi-channel audio such as an upmixed signal), or channel assignment of an audio signal in a surround sound configuration (e.g., a spatial assignment in a surround sound configuration, assignment in a 5.1, 7.1, or Atmos configuration).

In some implementations, determining the location of the speaker relative to the one or more other speakers is based on at least one of, radio frequency (RF) based proximity detection, ultra-wide band (UWB) based proximity detection, Bluetooth based proximity detection, or acoustic feedback-based proximity detection. In particular examples, two or more approaches are used to determine the location of the speaker relative to the other speaker(s). In some examples, the acoustic feedback-based proximity detection includes detecting acoustic signals from one or more speakers using at least one microphone. In particular examples, determining the location of the speaker relative to the other speaker(s) is performed across a communication channel, for example, Bluetooth, Wi-Fi, Zigbee, etc. In certain cases, the communication channel is established with a previous pairing of the speaker(s) and/or includes a security mechanism. In additional cases, the use of a previous pairing and/or security mechanism can mitigate snooping on the connection and/or accidental joining of a speaker group. In some examples, a user interface command is required prior to determining the location of the speaker. In particular examples, the user interface command can include a previous pairing command or a command in a software application on a paired smart device.

In various implementations, determining the location of the speaker relative to the one or more speakers is based on the radio frequency (RF) based proximity detection, wherein at least one speaker includes a set of RF anchors configured to aid in the RF based proximity detection.

In certain aspects, the at least one speaker includes two or more RF anchors and has a known orientation relative to a space. In some cases, the known orientation is based on a known, fixed position in space. In certain examples, determining the location of a speaker relative to the known fixed speaker can include triangulating the location of an RF tag on the speaker with the two or more RF anchors on the fixed speaker with the known orientation. In addition to a known orientation of the fixed speaker, approximate dimensions of the speaker can be used to determine the location of the additional speaker(s). Approximate dimensions can be determined based on locations of RF anchors and/or known specifications (e.g., dimensions) of the speaker. In various implementations, multiple RF anchors and multiple RF tags are used to determine the location of the additional speaker(s) relative to a fixed speakers. In certain examples, at least one speaker includes an ultra-wide bandwidth (UWB) antenna to aid in determining the relative location of speaker(s). In additional examples, the speaker(s) include a physical indicator (e.g., a physical outline, a recess, or a visible marker) to aid in placement of an external (or, modular) UWB antenna.

In particular implementations, the at least one speaker includes a soundbar.

In certain aspects, determining the location of the speaker relative to the one or more speakers is based on the acoustic feedback-based proximity detection. In certain cases, acoustic drivers and/or microphones on any of the speakers can be used to aid in proximity detection. In other cases, at least one acoustic driver and/or microphone on a speaker is used strictly for proximity detection in a designated mode, e.g., in response to a trigger. In some examples, a method further includes: detecting, using at least one microphone at the speaker or the one or more speakers, at least one acoustic signal from another speaker in a space, and determining the location of the speaker relative to the one or more speakers based on the at least one acoustic signal.

In some aspects, dynamically modifying the audio playback includes indicating a transitional state of the audio playback during the change in location.

In particular cases, indicating the transitional state includes at least one of, fading audio in or out, increasing or decreasing volume, or providing a visual or audible indicator of the transitional state. In certain cases, the visual or audible indicator includes one or more flashing lights, a chime, or a tune. The indicator of transitional state can be provided at one or more of the devices.

In certain implementations, the one or more other speakers are located in a space and the change in location of the speaker is either, into or out of the space, or within the space. In various implementations, the speakers are of a same make and model, or differ in at least one of make or model.

In some aspects, the space is defined by a proximity border, and movement of the speaker relative to the proximity border triggers at least one audio transition experience. In certain examples, the proximity border includes a digital fence. In some examples, the digital fence is adjustable, for example, via a user interface on a connected device such as a smart device. In further examples, shortcuts such as surround sound, channel, or other mode shortcuts are established for speaker locations within a fence. In particular cases, audio transition experiences can include a plurality of distinct experiences, such as sound-like-glitter, bloom-and-fade, or join-ongoing-room. In some examples, the coordinate location (e.g., X-Y or X-Y-Z) of a speaker can determine its role in an experience.

In some aspects, the audio transition experience includes at least one of: a first experience (e.g., sound-like-glitter) wherein, the speaker is outputting audio prior to the change in location and the one or more speakers is not outputting audio prior to the change in location, in response to the speaker entering the proximity border, initiating audio output at the one or more speakers, and maintaining the audio output at the one or more speakers in response to the speaker subsequently leaving the proximity border, a second experience (e.g., bloom-and-fade) wherein, the speaker is outputting audio prior to the change in location and the one or more speakers is not outputting audio prior to the change in location, in response to the speaker entering the proximity border, initiating audio output at the one or more speakers, and terminating the audio output at the one or more speakers in response to the speaker subsequently leaving the proximity border, a third experience (e.g., join-ongoing-room) wherein, the speaker is not outputting audio prior to the change in location and the one or more speakers is outputting audio prior to the change in location, and in response to the speaker entering the proximity border, initiating audio output at the speaker, a fourth experience wherein, the speaker and the one or more speakers are outputting audio prior to the change in location, and in response to the speaker entering the proximity border, re-assigning a role (e.g., volume, equalization, left channel, right channel, etc.) of at least one speaker, or a fifth experience wherein, the speaker and the one or more speakers are not outputting audio prior to the change in location, and in response to the speaker entering the proximity border, assigning a role to the speaker configured to take effect in response to a subsequent trigger. A subsequent trigger can include a power on/power off command, initiating playback, etc.

In certain aspects, initiating audio output can include grouping, acoustic property adjustment, etc. In some examples, transitions can include fading playback in/out, volume fading in/out, etc.

In particular aspects, determining the location of the speaker relative to the one or more other speakers is dictated by a proximity detection approach of a host speaker in a space. In some examples, the host speaker includes a soundbar or other fixed speaker in a space. In some aspects, the proximity detection approach of the host speaker includes a multi-transmitter/multi-receiver configuration or a single transmitter/single receiver configuration.

In some implementations, determining the location of the speaker relative to other speaker(s) includes a back channel communication between the speakers (and in some cases, additional devices). In particular cases, one of the speakers acts as a main unit. In certain aspects, that main unit is a fixed speaker in the space. The main unit can perform ranging processing and/or communicate with other speakers in the space.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a block diagram of a system including an accessory device and at least one audio device, according to various disclosed implementations.

FIG. 2 is flow diagram illustrating processes in a method according to various implementations.

FIG. 3 is a schematic diagram illustrating movement of speakers within a space.

FIG. 4 is an example chart showing distinct speaker experiences according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that configuring acoustic properties to be applied to an audio device based on detecting a device location can enhance the user experience.

As noted herein, conventional portable speakers and related approaches for managing audio output from such speakers can hinder the user experience. For example, it can be cumbersome to join conventional portable speakers to an existing speaker grouping and/or separate portable speakers from a grouping once joined. Further, conventional portable speakers and related approaches can fail to adapt to movement of the portable speakers within a space occupied by other speakers. Additionally, conventional approaches for assigning roles of speakers in a group, or when grouping or un-grouping, can be time-consuming and inefficient.

In contrast to conventional approaches and systems, various implementations include approaches for modifying audio playback of at least one speaker based on detecting a change in location of a speaker relative to one or more additional speakers in a space. In certain examples, audio playback includes at least one audio playback property (or, “acoustic property”) including, audio content, output volume, output directionality, output spatialization, frequency response, portions of an audio signal, channel assignment of an audio signal in a stereo configuration (e.g., Left or Right, multichannel, or derived multi-channel audio such as an upmixed signal), or channel assignment of an audio signal in a surround sound configuration (e.g., a spatial assignment in a surround sound configuration, assignment in a 5.1, 7.1, or Atmos configuration). In certain aspects, determining the location of the speaker relative to the other speaker(s) is based on at least one of, radio frequency (RF) based proximity detection, ultra-wide band (UWB) based proximity detection, Bluetooth based proximity detection, or acoustic feedback-based proximity detection. In particular examples, two or more approaches are used to determine the location of the speaker relative to the other speaker(s).

The approaches disclosed herein can enable application of beneficial speaker groupings and/or audio output settings in a dynamic manner, e.g., in response to changes in location of one or more speakers. These approaches can simplify and enhance the user interface experience, and/or improve the audio experience within a space.

Commonly labeled components in the FIGURES are considered to be substantially equivalent components for the purposes of illustration, and redundant discussion of those components is omitted for clarity.

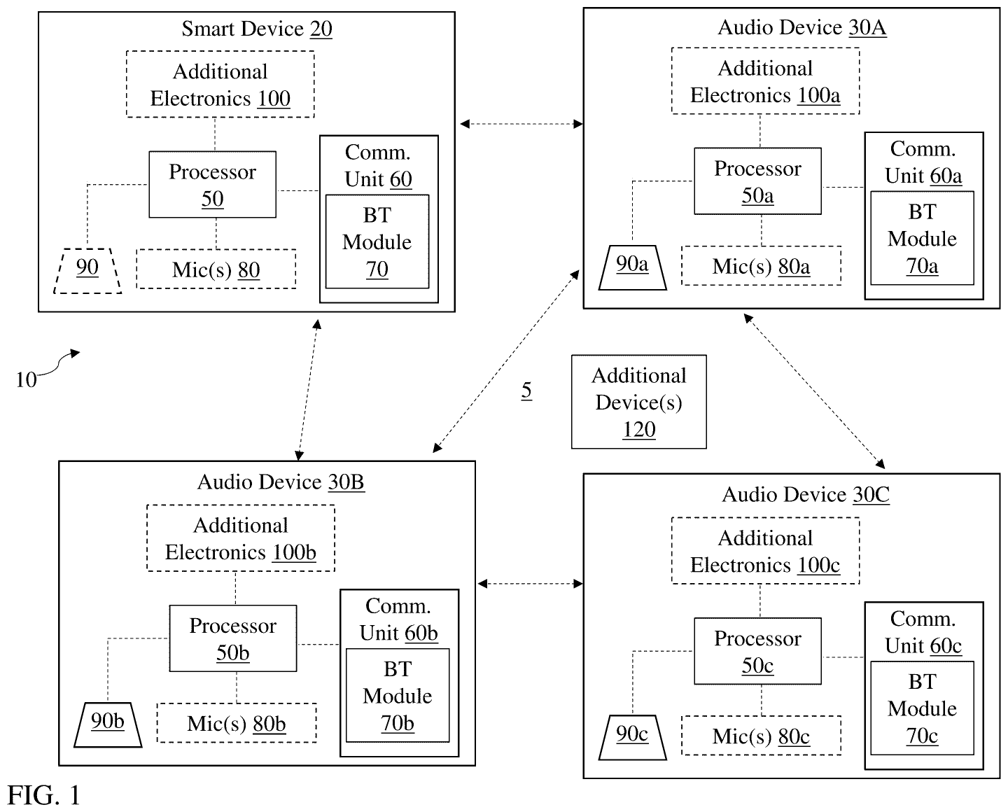

FIG. 1 shows an example of an environment (or, space) 5 including a system 10 including a set of devices according to various implementations. In various implementations, the devices shown in system 10 include a smart device (or simply, device) 20 and one or more audio devices 30 that are configured to interact with the device 20. In particular implementations, device 20 includes a smart phone, tablet, smart watch, smart television, or other device capable of running software (e.g., an application, or app) to communicate with and/or control aspects of the audio devices 30.

In certain implementations, the device 20 includes a processor 50 (or multiple processors 50) that can be configured for controlling audio output and/or assignment of a location or identity of additional devices such as audio devices 30, as further described herein. The device 20 can include additional electronics 100 such as a power manager, memory, sensors (e.g., IMUs, accelerometers/gyroscope/magnetometers, optical sensors, voice activity detection systems), etc. Additionally, the processor 50 can be configured to receive inputs from one or more additional components in the device to detect proximity and/or charging status of the audio device 30, identify the audio device 30, and/or communicate with additional devices in the space 5. In certain examples, the additional electronics 100 in the device 20 can include a communications unit (e.g., wireless communications unit) such as those described with reference to the audio devices 30 herein.

In certain cases, the space 5 includes a plurality of audio devices 30A, 30B, etc., that are capable of being connected with device 20, e.g., via any communications mechanism described herein. In further implementations, where the device 20 includes charging capabilities, one or more of the audio devices 30 is configured to connect with the device 20, e.g., for charging. In certain cases, the plurality of audio devices 30A, 30B, 30C are either, of a same make and a same model, or differing in at least one of make or model.

One or more of the audio devices 30 can include a portable speaker, such as a portable home speaker. It is understood that a “portable speaker” or a “portable home speaker” as described herein can refer to any of a number of speakers that are configured for wired and/or wireless operation, and are configured to change location. In certain cases, such speakers are labeled as “portable,” but this is not necessary in all implementations. Further, portable speakers and portable home speakers can be configured to charge in a dock (e.g., device 20), wirelessly charge, and/or remain connected to an external power source such as an outlet or additional device while outputting audio. Non-limiting examples of portable speakers provided by Bose Corporation (Framingham, MA, USA) can include the Bose Portable Smart Speaker, the Bose SoundLink Flex, the Bose SoundLink Micro, the Bose SoundLink Mini II, and/or the Bose SoundLink Revolve II (product names truncated for brevity). One or more audio devices described herein may be described as “fixed,” meaning that the audio device is designed to output audio in a static location or is configured to be mounted or otherwise fixed in a location. Certain examples of fixed speakers include wall or ceiling-mounted speakers, recessed speakers, speakers that form part of a surround sound unit in a home or other room entertainment system, and/or fixed speakers in a conference room, office, indoor/outdoor space, etc. A particular example of a fixed speaker is a soundbar, which may be placed in a single location for intended continued use, e.g., in front of or near a television, interface, or other screen, or in a central location in a space 5.

Any of the audio devices 30A, 30B, 30C can be configured to connect with device 20, however, it is understood that two or more of the audio devices 30 can also be configured to connect with device 20 and/or with additional similar devices 20, such as distinct smart devices in one or more locations. Two or more devices (e.g., audio devices 30) can communicate with one another using any communications protocol or approach described herein. In certain aspects, the system 10 is located in or around space 5, e.g., an enclosed or partially enclosed room in a home, office, theater, sporting or entertainment venue, religious venue, etc. In some cases, the space 5 has one or more walls and a ceiling. In other cases, the space 5 includes an open-air venue that lacks walls and/or a ceiling.

In certain cases, the audio device(s) 30 each include one or more processors (or, controllers) 50 and a communication (comm.) unit 60 coupled with the controller 50. In certain examples, the communication unit 60 includes a Bluetooth module 70 (e.g., including a Bluetooth radio), enabling communication with other devices over Bluetooth protocol. In addition to processor(s) 50a, 50b, 50c, the audio devices 30 can also include one or more microphones 80 (e.g., a microphone array), and a transducer 90 (e.g., an electro-acoustic transducer) for providing an audio output, e.g., in space 5. Further, the audio devices 30, can also include additional electronics 100, such as a power manager and/or power source (e.g., battery or power connector), memory, sensors (e.g., IMUs, accelerometers/gyroscope/magnetometers, optical sensors, voice activity detection systems), etc. In some cases, the memory may include a flash memory and/or non-volatile random access memory (NVRAM). Certain of the above-noted components depicted in FIG. 1 are optional, and are displayed in phantom.

In additional implementations, as described herein, the communication unit 60 and/or additional electronics 100 can include one or more RF devices and/or ultra-wide band (UWB) devices. For example, audio device(s) 30 can include one or more RF devices such as RF anchors or tags, which can be detectable by a communication unit 60 and/or RF anchors or tags on another device 20 or audio device 30 in range (e.g., in space 5). Further, audio device(s) 30 can include one or more UWB devices such as a UWB sensor or tag that are detectable by a communication unit 60 and/or UWB sensor or tag on another device 20 or audio device 30 in range (e.g., in space 5).

In certain cases, the processor(s) 50 can include one or more microcontrollers or processors having a digital signal processor (DSP). In some cases, the processor(s) 50 are referred to as processing circuit(s) or control circuit(s). The processor(s) 50 may be implemented as a chipset of chips that include separate and multiple analog and digital processors.

In particular cases, the processor(s) 50 may provide, for example, for coordination of other components of the audio device(s) 30 and/or device 20, such as control of acoustic properties for audio playback at the audio device(s) 30. In various implementations, processor(s) 50 in audio device 30 include a location-based acoustic property control module which can include software and/or hardware for performing control processes described herein. For example, processor(s) 50 can include a location-based acoustic property control module in the form of a software stack having instructions for controlling functions in outputting audio based on detecting a location and/or change in location of an audio device 30 relative to other audio device(s) 30 and/or device 20 according to any implementation described herein.

The communication unit 60 can include the BT module 70 configured to employ a wireless communication protocol such as Bluetooth, along with additional network interface(s) such as those employing one or more additional wireless communication protocols such as IEEE 802.11, Bluetooth Low Energy, or other local area network (LAN) or personal area network (PAN) protocols such as Wi-Fi. In particular implementations, communication unit 60 is particularly suited to communicate with other communication units 60 in audio devices 30 and/or additional device(s) such as smart devices (e.g., smartphones, tablets, smart watches) via Bluetooth. In still further implementations, the communication unit 60 is configured to communicate with any other device in the system 10 wirelessly via one or more of: Bluetooth (BT); BT low-energy (LE) audio; broadcast such as via synchronized unicast; a synchronized downmixed audio connection over BT or other wireless connection (also referred to as SimpleSync™, a proprietary connection protocol from Bose Corporation, Framingham, MA, USA); and multiple transmission streams such as broadcast. In still further implementations, the communication unit 60 is configured to communicate with any other device in the system 10 via additional wireless communication approaches (e.g., Wi-Fi, RF, UWB) and/or a hard-wired connection, e.g., between any two or more devices.

In certain example implementations, additional devices 120 such as smart phones, smart watches, tablets, etc. in space 5 can include similar components (e.g., a processor 50 and communications unit 60) as the audio device(s) 30. Additional device(s) 120 can be configured to communicate with any device described herein. Further, in certain cases, distinct audio devices 30A, 30B, 30C can include distinct speakers in the space 5, and in particular cases, can include one or more speakers in the space 5. In some examples, as noted herein, one or more of the audio devices 30 can include a fixed speaker or a speaker with a known location.

In particular cases, the device 20 and/or audio devices 30 can further include a device identifier that is unique to the device or the type of device. In some cases, the identifier can be stored in memory at the device(s) 20, 30. In certain implementations, the identifier includes a BT identifier and/or an RF identifier. In still further implementations, the identifier includes a unique, non-writable identifier, which can include an identifier (ID), model type, and/or capabilities indicator, e.g., ID #X, hasNfc, hasMic, hasBattery. In certain cases, the other devices 20, 30 can be configured to detect the device identifier, e.g., via physical connection such as a hard-wired connection, and/or via wireless signals received via the communication unit 60.

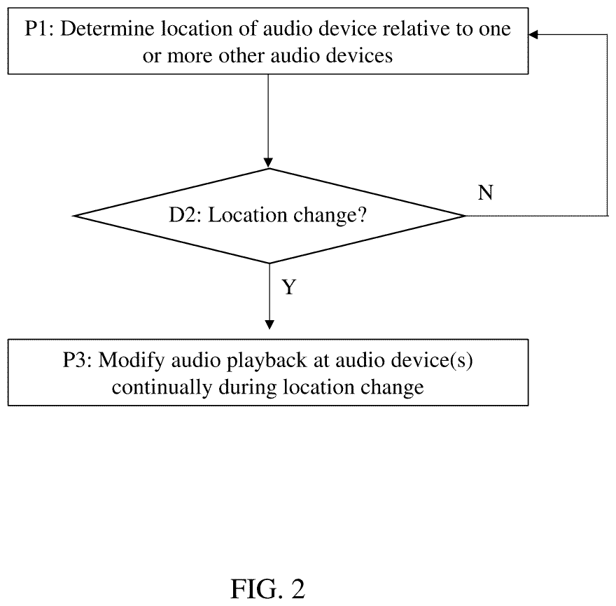

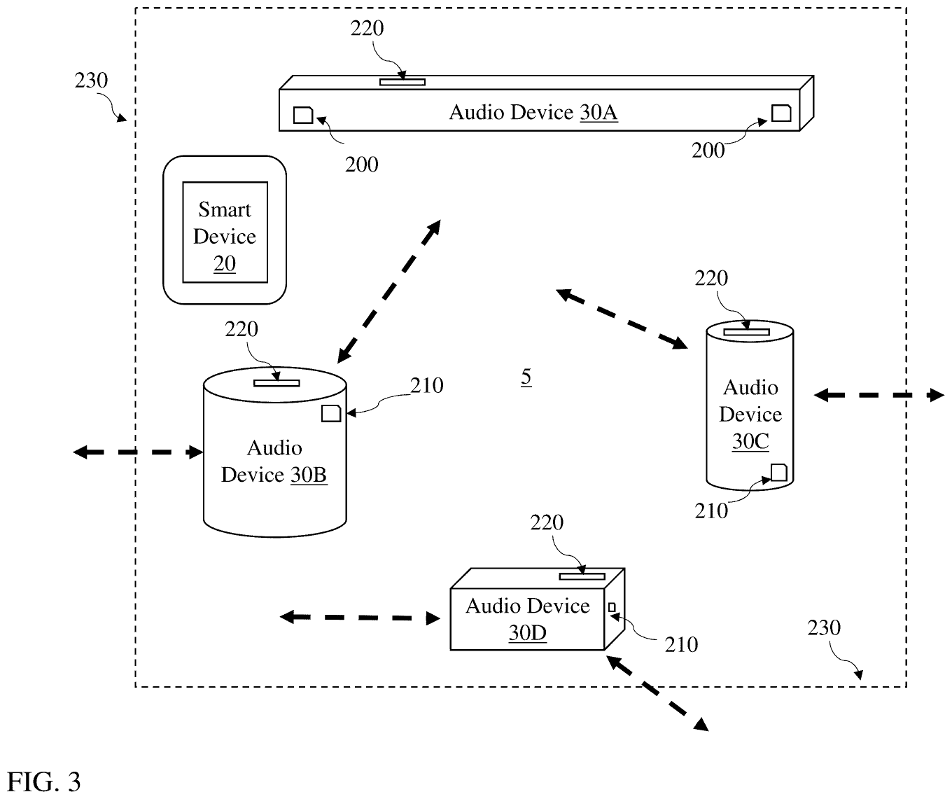

FIG. 2 is a flow diagram illustrating processes in a method of controlling audio output at audio device(s) 30 based on determining a location of an audio device (or, speaker) 30 relative to one or more other speakers 30. FIG. 3 is a schematic diagram showing a plurality of speakers 30 in space 5. In this example implementation, audio device (speaker) 30A includes a soundbar, audio device 30B includes a smart home speaker, and audio devices 30C and 30B include portable speakers. A smart device 20 such as a tablet or audio system controller can be present in certain examples. It is understood that any of the audio devices 30 can take any form described herein, and these distinct types of audio device are merely illustrative. As noted by dashed lines, one or more of the audio devices 30 is configured to move within space 5, and/or into or out of space 5.

With reference to FIGS. 2 and 3, a first process (P1) can include determining the location of an audio device 30 relative to one or more other audio devices 30. In one non-limiting example, the location of audio devices 30B, 30C, or 30D is determined relative to one or more additional audio devices 30, e.g., audio device 30A. In some such examples, the audio device 30A is characterized as a host, base, or “fixed” speaker. In certain examples, that host, base, or “fixed” speaker is one that has a hard-wired connection to a power source and is not intended for portable use.

In particular implementations, the processor 50 at one or more devices (e.g., an audio device 30) determines the location of a corresponding audio device 30 relative to other audio device(s) 30. Audio device 30B is used in one example discussion, but the location of any audio device 30 can be determined according to the approaches described herein. In certain implementations, determining the location of an audio device 30B relative to the one or more other audio devices 30 is based on at least one of, radio frequency (RF) based proximity detection, ultra-wide band (UWB) based proximity detection, Bluetooth (BT) based proximity detection, or acoustic feedback-based proximity detection. In particular examples, two or more approaches are used to determine the location of the audio device 30B relative to the other audio device(s) 30, e.g., RF and UWB, RF and BT, UWB and acoustic feedback, RF and acoustic feedback, etc.

In some examples, the acoustic feedback-based proximity detection includes detecting acoustic signals from one or more audio devices 30 using at least one microphone 80 (FIG. 1). In particular examples, determining the location of the audio device 30B relative to the other audio device(s) 30 is performed across a communication channel, for example, Bluetooth, Wi-Fi, Zigbee, etc. In certain cases, the communication channel is established with a previous pairing of the audio device(s) 30 and/or includes a security mechanism. In additional cases, the use of a previous pairing and/or security mechanism can mitigate snooping on the connection and/or accidental joining of a speaker group (e.g., a grouping of audio devices 30). In some examples, a user interface command is required prior to determining the location of the speaker. In certain cases, a user interface command can include a command at an interface on smart device 20 (e.g., in a software application controlling audio device(s) 30), and/or a command received at the audio device(s) 30, such as a button press or voice command. In particular examples, the user interface command can include a previous pairing command. It is understood that the acoustic feedback-based proximity detection approach can be differentiated from a conventional acoustic feedback loop, e.g., in a public address (PA) system that can result in an undesirable output such as a howl or a squeal.

In additional implementations, the use of a previous pairing and/or security mechanism can include back-channel RF communication. In some cases, the back-channel RF communication is used to assist an acoustic feedback-based proximity detection approach. In further implementations, acoustic feedback-based proximity detection can be used to verify that two or more devices (e.g., audio devices 30 and/or smart devices 20) are in the same enclosed space (e.g., where space 5 is a room with walls) because RF-based location can be used for detection through walls.

In various implementations, determining the location of the audio device 30B relative to the one or more audio devices 30 is based on the radio frequency (RF) based proximity detection. In certain implementations, at least one audio device 30 includes a set of RF anchors 200 configured to aid in the RF based proximity detection. In certain cases, RF anchors 200 are located on one or more audio devices 30 in space 5. In a particular example, one or more speakers, e.g., audio device 30A, includes two or more RF anchors 200 and has a known orientation relative to space 5. In some cases, the known orientation is based on a known, fixed position in space 5. For example, the audio device 30A can include a sound bar that is placed in a location proximate an entertainment system, a wall, or a television or other monitor. In particular cases, the audio device 30A is connected to a power source such as an outlet in a fixed position, and is oriented outward toward a space 5, e.g., such that a front of the audio device 30A is directed into a center or middle of space 5. In certain examples, determining the location of an audio device 30B, 30C, 30D, etc., relative to the known fixed audio device 30A can include triangulating the location of an RF tag 210 on audio device 30B, 30C, 30D, with the two or more RF anchors 200 on the fixed audio device 30A with the known orientation. For example, the processor 50a at audio device 30A can process RF signals detected at the RF anchors 200 from each RF tag 210 to determine whether a given audio device (e.g., audio device 30B, 30C, 30D) is closer to one of the RF anchors 200 (e.g., as indicated by shorter relative response time). In certain cases, RF anchors 200 and RF tags 210 can include similar RF identifier features. However, in other cases, RF anchors 200 and tags 210 differ in at least one characteristic (e.g., size, signal detection strength, etc.) to differentiate anchors 200 from tags 210. In various implementations, anchors 200 and tags 210 can be substituted for one another without deviating from the disclosed implementations.

In additional to a known orientation of the fixed audio device 30A, approximate dimensions of the audio device 30A can be used to determine the location of the additional audio device(s) 30B, 30C, 30D. Approximate dimensions can be determined based on locations of RF anchors 200 and/or known specifications (e.g., dimensions) of the audio device 30A. Known dimensions can be based on a make/model/type of the audio device 30A, e.g., the Bose TV speaker, Bose Smart Ultra Soundbar, or the Bose Smart Soundbar 600 (all available from Bose Corporation). In various implementations, multiple RF anchors 200 and multiple RF tags 210 are used to determine the location of the additional audio device(s) 30B, 30C, 30D relative to a fixed speaker, e.g., audio device 30A. In certain examples, at least one audio device 30 includes an ultra-wide bandwidth (UWB) antenna 220 to aid in determining the relative location of audio device(s) 30. In additional examples, the audio device(s) 30 include a physical indicator (e.g., a physical outline, a recess, or a visible marker) to aid in placement of an external (or, modular) UWB antenna 220.

In still further implementations, determining the location of the audio device (e.g., audio device 30B, 30C, etc.) relative to the one or more audio devices (e.g., audio device 30B, audio device 30D, etc.) is based on acoustic feedback-based proximity detection. In certain cases, acoustic drivers (or, transducers) 90 and/or microphones 80 on any of the audio devices 30 or the smart device 20 (FIG. 1) can be used to aid in proximity detection. In other cases, at least one acoustic transducer 90 and/or microphone 80 on an audio device 30 is used strictly for proximity detection in a designated mode, e.g., in response to a trigger. For example, in response to activation of a location detection module in the processor 50 (e.g., processor 50a at audio device 30A), at least one transducer 90a and microphone 80a are activated for proximity detection. In some examples, an acoustic feedback-based approach can further include: detecting, using at least one microphone (e.g., 80a) at the audio device (e.g., 30A), or the microphone(s) 80b, 80c, etc. at one or more audio device(s) 30B, 30C, at least one acoustic signal from another audio device (e.g., 30D) in space 5, and determining the location of the audio device 30D relative to the one or more audio device(s) 30A, 30B, 30C, based on the at least one acoustic signal. In a particular example, test signals such as chimes, tunes, etc., can be used for location detection between audio devices 30. In additional cases, audio device(s) 30 use acoustic output signals (e.g., music playback or streaming, entertainment system output, etc.) to determine the location of one or more audio devices 30.

In some examples, in the acoustic feedback-based proximity detection approach, each audio device 30 providing output records its own output along with playback from other devices (e.g., audio devices 30).

In additional implementations, acoustic feedback-based proximity detection can include using transducers 90 as acoustic anchors in a similar manner as RF anchors 200. In such cases, the location, orientation, etc., of an audio device (e.g., audio device 30A) with a known spacing between transducers 90 can be determined based on detected distinctions in acoustic signals (e.g., in time differences, phase differences, and/or channel differences) received from the transducers 90. In further cases, where microphones 80 are co-located with transducers 90 in known locations on audio device(s) 30, acoustic signals detected as those known microphone locations can be used to aid in determining the proximity of an audio device (e.g., 30A) to one or more other devices 20, 30. In a particular example, signals received at distinct microphones 80 on a device (e.g., audio device 30A) with a known spacing between microphones 80 can indicate a location of an audio source (e.g., audio device 30B, 30C, etc.), e.g., based on distinctions in time received and/or phase.

Returning to FIG. 2, following determining the location of the audio device(s) 30 relative to one another in space 5, the processor 50 (e.g., processor 50a) determines whether the location of the audio device(s) 30 has changed (decision D2). In particular cases, the processor 50 is configured to determine that the audio device(s) 30 are moving within space 5, are entering space 5, and/or are leaving space 5. If not (No to decision D2), the processor 50 can periodically, or continuously attempt to determine the location of additional devices 30 in space 5, e.g., in response to a trigger such as a power cycle, detecting an acoustic signal in space 5, detecting a connection attempt between audio devices 30 and/or with device 20, and/or detecting movement of one or more devices based on a sensor in additional electronics 100 (e.g., where an input from an IMU indicates movement of the device(s) 20, 30), etc. In certain aspects, the processor 50 has prior knowledge of a location of the audio device(s) 30, and compares the determined location (process P1) with that prior known location to detect a change (Yes to decision D2).

In particular aspects, determining the location of the audio device (e.g., audio device 30B, 30C, etc.) relative to the one or more other audio devices (e.g., audio device 30A) is dictated by a proximity detection approach of a host speaker in a space. In some examples, the host speaker includes a soundbar or other fixed speaker in a space, e.g., audio device 30A. In some aspects, the proximity detection approach of the host speaker 30A includes a multi-transmitter/multi-receiver configuration or a single transmitter/single receiver configuration. In such cases, the host speaker 30A includes at least one transmitter/receiver and is configured to transmit and receive signals from one or more additional audio devices 30 in space 5 to detect their respective locations, e.g., on a continuous or periodic basis. In certain cases, the host speaker 30A pings or broadcasts a signal (e.g., via UWB, RF, BT, etc.) to elicit a response from additional audio devices 30 and determine respective locations.

In some implementations, determining the location of the audio device(s), e.g., audio device(s) 30B, 30C, etc., relative to other audio device(s), e.g., audio device 30A, includes a back channel communication between the audio devices (and in some cases, additional devices). As noted herein, in particular cases, one of the audio devices (e.g., audio device 30A) acts as a main unit. In certain aspects, that main unit can perform ranging processing and/or communicate with other speakers in the space 5.

In response to that detected change (e.g., movement), in process P3 the audio playback of at least one audio device 30 is modified. In certain cases, modifying the audio playback is performed in direct response to the detected change in location of the audio device(s) 30, for example, without additional user intervention (e.g., without a user interface command). In particular implementations, modifying the audio playback is performed dynamically, for example, continually while the change in location of the audio device 30 is occurring. However, in other examples, it is not necessary to continually modify the audio playback during the movement of the audio device 30. In these cases, the audio playback at audio device 30 is modified after detecting the change in location, which in some cases, is after the audio device 30 has been relocated within space 5.

In particular aspects, the audio playback includes at least one audio playback property (or, “acoustic property”) including, audio content, output volume, output directionality, output spatialization, frequency response, portions of an audio signal, channel assignment of an audio signal in a stereo configuration (e.g., Left or Right, multichannel, or derived multi-channel audio such as an upmixed signal), or channel assignment of an audio signal in a surround sound configuration (e.g., a spatial assignment in a surround sound configuration, assignment in a 5.1, 7.1, or Atmos configuration).

In particular examples, dynamically modifying the audio playback includes indicating a transitional state of the audio playback during the change in location. In particular cases, indicating the transitional state includes at least one of, fading audio in or out, increasing or decreasing volume, or providing a visual or audible indicator of the transitional state. In certain cases, the visual or audible indicator includes one or more flashing lights, a chime, or a tune. The indicator of transitional state can be provided at one or more of the devices, e.g., audio device(s) 30 and/or smart device 20.

As noted herein and illustrated in FIG. 3, the audio devices (speakers) 30 are located within a space 5, which in certain examples is defined by a proximity border 230. In certain implementations, the change in location of the audio device 30 is either, into or out of the space 5, or within the space 5. As noted herein, in various implementations, the audio devices 30 are of a same make and model, or differ in at least one of make or model (e.g., soundbar, smart speaker, portable speaker, and/or portable smart speaker etc.).

In some aspects, movement of the audio device 30 relative to the proximity border 230 triggers at least one audio transition experience. In certain examples, the proximity border 230 includes a digital fence. In some examples, the digital fence is adjustable, for example, via a user interface on a connected device such as a smart device 20. In further examples, shortcuts such as surround sound, channel, or other mode shortcuts are established for audio device 30 locations within a fence. In particular cases, audio transition experiences can include a plurality of distinct experiences, such as sound-like-glitter, bloom-and-fade, or join-ongoing-room. In some examples, the coordinate location (e.g., X-Y or X-Y-Z) of an audio device 30 can determine its role in an experience.

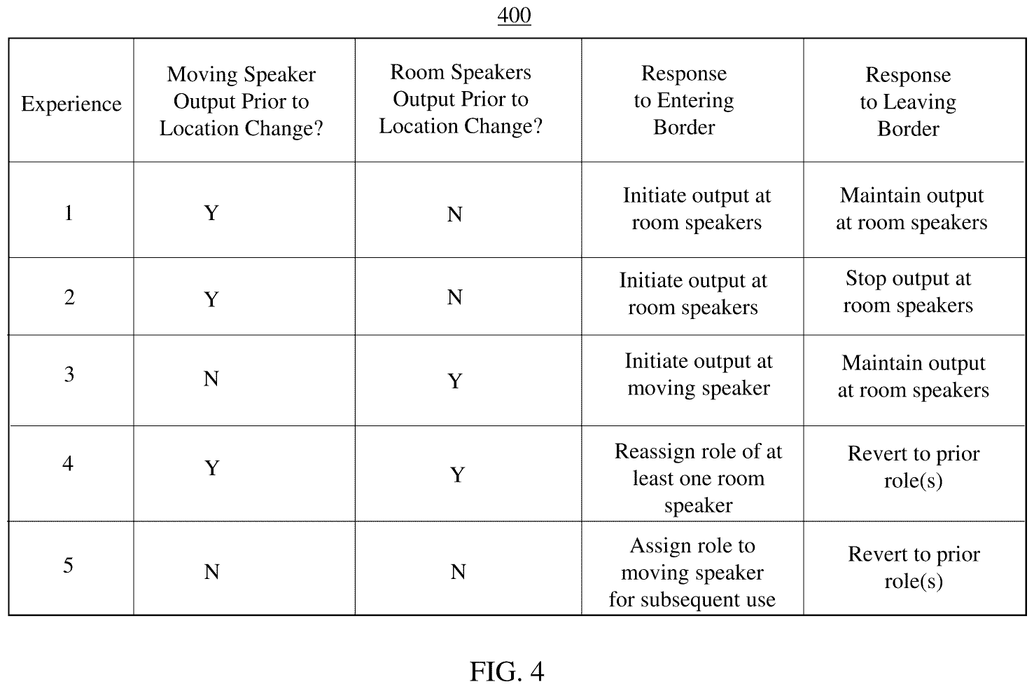

A chart 400 in FIG. 4 illustrates aspects of distinct audio transition experiences according to some example implementations. Five (5) non-limiting example experiences are illustrated in chart 400, although aspects of these experiences can be combined and/or modified according to any implementation herein. In some aspects, the audio transition experience includes at least one of:
I) A first experience (e.g., sound-like-glitter) where the audio device (or, speaker), e.g., audio device 30C (FIG. 3) is outputting audio prior to the change in location, and the one or more audio devices in the space 5 (e.g., audio devices 30A, 30B, 30D) are not outputting audio prior to the change in location. In response to the audio device 30C entering the proximity border 230, audio output is initiated at the audio devices 30 in space 5 (e.g., audio devices 30A, 30B, 30D), and maintained at those audio devices 30A, 30B, 30D in response to the audio device 30C subsequently leaving the proximity border 230.
II) A second experience (e.g., bloom-and-fade) where the audio device, e.g., audio device 30C is outputting audio prior to the change in location and the one or more audio devices 30 in the space 5 (e.g., audio devices 30A, 30B, 30D) are not outputting audio prior to the change in location. In response to the audio device 30C entering the proximity border 230, audio output is initiated at the audio devices 30A, 30B, 30D, and terminated at the audio devices 30A, 30B, 30D in response to the audio device 30C subsequently leaving the proximity border 230.
III) A third experience (e.g., join-ongoing-room) where the audio device, e.g., audio device 30C is not outputting audio prior to the change in location and the one or more audio devices 30 in the space 5 (e.g., audio devices 30A, 30B, 30D) are outputting audio prior to the change in location. In response to the audio device 30C entering the proximity border 230, audio output is initiated at the audio device 30C. In certain of these examples, audio output continues at the audio devices 30A, 30B, 30D in response to the audio device 30C subsequently leaving the proximity border 230. In further examples in this experience, audio output at audio device 30C is terminated when it leaves the border 230.
IV) A fourth experience where the audio device, e.g., audio device 30C and the room audio device(s) (e.g., audio devices 30A, 30B, and/or 30D) are outputting audio prior to the change in location. In response to the audio device 30C entering the proximity border 230, a role (e.g., volume, equalization, left channel, right channel, etc.) of one or more of the room speakers 30A, 30B, 30D is reassigned. In such cases, the audio device 30C can join the group of audio devices 30A, 30B, 30D in a complementary role, e.g., with matching volume and/or equalization, and/or a complementary channel assignment. In certain cases, in response to the audio device 30C leaving the proximity border 230, the remaining audio devices 30A, 30B, 30D can revert to their previous roles prior to the audio device 30C entering the group. In some of these cases, the audio output at devices 30A, 30B, 30D is continued in response to audio device 30C leaving the proximity border 230.
V) A fifth experience where the audio device (e.g., audio device 30C) and the room audio device(s) 30A, 30B, 30D are not outputting audio prior to the change in location. In response to the audio device 30C entering the proximity border 230, a role is assigned to the audio device 30C that is configured to take effect in response to a subsequent trigger. A subsequent trigger can include a power on/power off command at one or more of the audio devices 30, initiating audio output at one or more of the audio devices 30, etc. In certain examples, in response to the audio device 30C leaving the proximity border 230, the audio devices 30A, 30B, 30D can revert to their previous roles prior to the audio device 30C entering the group.

In some implementations, as noted herein, initiating audio output can include grouping, acoustic property adjustment, etc. In some examples, transitions can include fading playback in/out, volume fading in/out, outputting a chime or tune, etc.

As described herein, audio devices 30 can be configured or assigned acoustic properties for output, e.g., as stand-alone speakers or as part of a group. In particular examples, acoustic properties can be configured using a software application running on a connected smart device, e.g., smart device 20 or another device 120 in the space 5 (FIG. 1). In some examples, the software application includes an audio configuration engine for the audio device 30, which can enable acoustic property selection, profile building and/or selection, etc. In certain cases, the acoustic properties includes aspects such as: equalization, channel assignment, volume, role relative to another audio device, or grouping relative to another audio device.

In certain example implementations, locations of audio devices 30 can be assigned or otherwise determined relative to spaces and locations in a home or residence, but various additional examples are possible, e.g., in an office building, house of worship, restaurant, entertainment venue, etc. Locations can be assigned via a software application (or, app) running on smart device 20 or another device 120, e.g., at startup, after introducing an audio device 30 to a space 5, and/or in response to a grouping update. In various examples, distinct spaces (e.g., indoors v. outdoors) can be further defined by locations within a space (e.g., living room v. kitchen, or patio). Proximity designations such as “near entry,” “near window,” or “near doorway” can be used, in some examples, to designate areas within a location. Specific locations within a space can be further designated by one or more conventional triangulation techniques and/or signal strength detection algorithms, e.g., using Wi-Fi, RF, BT, UWB etc. Further, as described herein, location assignment for an audio device 30 can be performed during setup of the audio device 30, or during a restart of the audio device 30 such as when the device is plugged into a power source such as an outlet.

In particular examples, the location of an audio device 30 is assigned to an X-Y coordinate in space 5, or an X-Y-Z coordinate in space 5. In particular cases, audio devices 30 can be connected with a dock or fixed accessory, which can include characteristics of a smart device 20 or another device 120 (FIG. 1). In some aspects, the location of one or more audio devices 30 is assigned based on a hard-wired connection, such as to a power source, and/or based on a docked location. While various implementations are described with respect to a host, or fixed audio device 30 such as audio device 30A (FIG. 3), it is understood that two or more audio devices 30 can function as host, or reference devices in a space 5. For example, referring back to FIG. 3, two distinct audio devices 30 with anchors 200 could be used in place of the audio device 30A that has two anchors 200, e.g., to determine the location of additional audio devices 30B, 30C, 30D, etc. Various examples of location detection and coordination of output are further described in U.S. patent application Ser. No. 18/385,997, (Dynamic Portable Speaker Grouping, filed Nov. 1, 2023), the entire contents of which are incorporated by reference herein.

In certain additional implementations, acoustic proximity-based approaches can include determining (and in some cases, additionally assigning) a location of a device (e.g., audio device 30D) based on a known location of two or more devices (e.g., 30A, 30B) that have a microphone 80 and/or transducer 90. In certain of these cases, the audio devices 30A, 30B with a known location are configured to detect audio output signals from the audio device 30D with an unknown location. Based on distinctions between the audio signals (e.g., time, phase, etc.) received from audio device 30D at the audio devices 30A, 30B, audio device(s) 30A, 30B can determine a location (e.g., proximity) of audio device 30D to one or both of the audio devices 30A, 30B. In certain of these cases, the audio device 30D need not have a microphone to utilize this acoustic proximity-based location approach.

In certain examples, the location of an audio device 30 is assigned as at least one of, an outdoor indicator, an indoor indicator, a floor within a building, a room within a building, or a position in a room within a building. In further examples, location of the audio device 30 is used to control object-based audio output according to a set of acoustic properties. As described herein, in various examples, the location (or, location identity) of an audio device (e.g., audio device 30) is updated in response to moving the audio device 30 to a distinct location in an environment, or between environments.

In certain examples, acoustic properties (e.g., equalization, channel assignment, volume, role relative to another audio device, or grouping relative to another audio device for audio playback) can be defined by one or more attributes, at least some of which are adjustable. In certain non-liming examples, acoustic properties can be controlled according to attributes such as: equalization, channel, volume, role, and/or grouping. Additional aspects of controlling acoustic properties, grouping and ungrouping are described in U.S. patent application Ser. No. 18/385,997, previously incorporated by reference herein.

In any case, the systems and approaches described according to various implementations have the technical effect of enhancing speaker control, in particular, control of a one or more speakers in dynamic environment (e.g., with a speaker location change). Using location-based audio output adjustments to control one or more speakers, group and un-group portable speakers, etc., can provide an efficient, effective mechanism for automatically applying acoustic properties to one or more audio devices. In certain cases, the location-based approaches for controlling acoustic properties and/or groupings can enable smooth transitions between operating modes and usage scenarios. Further, the location-based approaches described herein allow for multiple portable devices (e.g., audio devices) to be used interchangeably within immersive groups, e.g., dynamically assuming roles based on location. These approaches offer flexibility and versatility, and reduce friction in providing desirable audio experiences.

Various wireless connection scenarios are described herein. It is understood that any number of wireless connection and/or communication protocols can be used to couple devices in a space, e.g., space 5 (FIG. 1). Examples of wireless connection scenarios and triggers for connecting wireless devices are described in further detail in U.S. patents application Ser. Nos. 17/714,253 (filed on Apr. 4, 2022) and 17/314,270 (filed on May 7, 2021), each of which is hereby incorporated by reference in its entirety).

It is further understood that any RF protocol could be used to communicate between devices according to implementations, including Bluetooth, Wi-Fi, or other proprietary or non-proprietary protocols. In implementations that utilize Bluetooth LE Audio, a unicast topology could be used for a one-to-one connection between speakers and/or devices in space 5. In some implementations, an LE Audio broadcast topology (such as Broadcast Audio) could be used to transmit one or more sets of audio data to multiple sets of speakers.

The above description provides embodiments that are compatible with BLUETOOTH SPECIFICATION Version 5.2 [Vol 0], 31 Dec. 2019, as well as any previous version(s), e.g., version 4.x and 5.x devices. Additionally, the connection techniques described herein could be used for Bluetooth LE Audio, such as to help establish a unicast connection. Further, it should be understood that the approach is equally applicable to other wireless protocols (e.g., non-Bluetooth, future versions of Bluetooth, and so forth) in which communication channels are selectively established between pairs of stations. Further, although certain embodiments are described above as not requiring manual intervention to initiate pairing, in some embodiments manual intervention may be required to complete the pairing (e.g., “Are you sure?” presented to a user of the source/host device), for instance to provide further security aspects to the approach.

In some implementations, the host-based elements of the approach are implemented in a software module (e.g., an “App”) that is downloaded and installed on the source/host (e.g., a “smartphone”), in order to provide the location-based audio output control aspects according to the approaches described above. In particular cases, functions such as audio controls for a group of audio devices can be controlled by a centralized interface command, e.g., a command at an interface on one of the audio devices (e.g., audio device(s) 30A, 30B, 30C, etc.), an interface at the smart device 20, and/or an interface at additional device 120. For example, a software module (e.g., an App) at the smart device 20 and/or additional device 120 can be used to control audio output to an entire group of audio devices while grouped. In certain cases, the centralized interface command can include a command at a single interface.

While the above describes a particular order of operations performed by certain implementations of the invention, it should be understood that such order is illustrative, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, unless otherwise noted, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

A number of implementations have been described. Nevertheless, it will be understood that additional modifications may be made without departing from the scope of the inventive concepts described herein, and, accordingly, other embodiments are within the scope of the following claims.

We claim:

1. A method comprising:
determining a location of a speaker relative to one or more other speakers; and
in response to a change in the location of the speaker relative to the one or more other speakers, dynamically modifying audio playback of at least one of the speaker or the one or more other speakers such that the modifying of the audio playback continually occurs while the change in the location of the speaker occurs.

2. The method of claim 1, wherein the audio playback includes at least one audio playback property including,
audio content, output volume, output directionality, output spatialization, frequency response, portions of an audio signal, channel assignment of an audio signal in a stereo configuration, or channel assignment of an audio signal in a surround sound configuration.

3. The method of claim 1, wherein determining the location of the speaker relative to the one or more other speakers is based on at least one of,
radio frequency (RF) based proximity detection, ultra-wide band (UWB) based proximity detection, Bluetooth based proximity detection, or acoustic feedback-based proximity detection.

4. The method of claim 3, wherein determining the location of the speaker relative to the one or more speakers is based on the radio frequency (RF) based proximity detection, wherein at least one speaker includes a set of RF anchors configured to aid in the RF based proximity detection.

5. The method of claim 4, wherein the at least one speaker includes two or more RF anchors and has a known orientation relative to a space.

6. The method of claim 4, wherein the at least one speaker includes a soundbar.

7. The method of claim 3, wherein determining the location of the speaker relative to the one or more speakers is based on the acoustic feedback-based proximity detection, the method further comprising,
detecting, using at least one microphone at the speaker or the one or more speakers, at least one acoustic signal from another speaker in a space, and
determining the location of the speaker relative to the one or more speakers based on the at least one acoustic signal.

8. The method of claim 1, wherein dynamically modifying the audio playback includes indicating a transitional state of the audio playback during the change in location,
wherein indicating the transitional state includes at least one of,
fading audio in or out, increasing or decreasing volume, or providing a visual or audible indicator of the transitional state.

9. The method of claim 1, wherein the one or more other speakers are located in a space and wherein the change in location of the speaker is either,
into or out of the space, or within the space.

10. The method of claim 9, wherein the space is defined by a proximity border, and wherein movement of the speaker relative to the proximity border triggers at least one audio transition experience, wherein the audio transition experience includes at least one of:
a first experience wherein,
the speaker is outputting audio prior to the change in location and the one or more speakers is not outputting audio prior to the change in location,
in response to the speaker entering the proximity border, initiating audio output at the one or more speakers, and
maintaining the audio output at the one or more speakers in response to the speaker subsequently leaving the proximity border,
a second experience wherein,
the speaker is outputting audio prior to the change in location and the one or more speakers is not outputting audio prior to the change in location,
in response to the speaker entering the proximity border, initiating audio output at the one or more speakers, and
terminating the audio output at the one or more speakers in response to the speaker subsequently leaving the proximity border,
a third experience wherein,
the speaker is not outputting audio prior to the change in location and the one or more speakers is outputting audio prior to the change in location, and
in response to the speaker entering the proximity border, initiating audio output at the speaker,
a fourth experience wherein,
the speaker and the one or more speakers are outputting audio prior to the change in location, and
in response to the speaker entering the proximity border, re-assigning a role of at least one speaker, or
a fifth experience wherein,
the speaker and the one or more speakers are not outputting audio prior to the change in location, and
in response to the speaker entering the proximity border, assigning a role to the speaker configured to take effect in response to a subsequent trigger.

11. The method of claim 1, wherein determining the location of the speaker relative to the one or more other speakers is dictated by a proximity detection approach of a host speaker in a space.

12. A speaker, comprising:
an electro-acoustic transducer; and
a processor coupled with the electro-acoustic transducer, the processor programmed to:
determine a location of the speaker relative to one or more other speakers; and
in response to a change in the location of the speaker relative to the one or more other speakers, provide instructions to dynamically modify audio playback of at least one of the speaker or the one or more other speakers such that the modifying of the audio playback continually occurs while the change in the location of the speaker occurs.

13. The speaker of claim 12, wherein the audio playback includes at least one audio playback property including,
audio content, output volume, output directionality, output spatialization, frequency response, portions of an audio signal, channel assignment of an audio signal in a stereo configuration, or channel assignment of an audio signal in a surround sound configuration.

14. The speaker of claim 12, wherein determining the location of the speaker relative to the one or more other speakers is based on at least one of,
radio frequency (RF) based proximity detection, ultra-wide band (UWB) based proximity detection, Bluetooth based proximity detection, or acoustic feedback-based proximity detection.

15. The speaker of claim 14, wherein the at least one speaker includes a soundbar, wherein determining the location of the speaker relative to the one or more speakers is based on the radio frequency (RF) based proximity detection, wherein the soundbar includes a set of at least two RF anchors configured to aid in the RF based proximity detection, and wherein the soundbar has a known orientation relative to a space.

16. The speaker of claim 14, wherein determining the location of the speaker relative to the one or more speakers is based on the acoustic feedback-based proximity detection, the processor further programmed to,
detect, using at least one microphone at the speaker or the one or more speakers, at least one acoustic signal from another speaker in a space, and
determine the location of the speaker relative to the one or more speakers based on the at least one acoustic signal.

17. The speaker of claim 12, wherein dynamically modifying the audio playback includes indicating a transitional state of the audio playback during the change in location, wherein indicating the transitional state includes at least one of,
fading audio in or out, increasing or decreasing volume, or providing a visual or audible indicator of the transitional state.

18. The speaker of claim 12, wherein the one or more other speakers are located in a space and wherein the change in location of the speaker is either,
into or out of the space, or within the space.

19. The speaker of claim 18, wherein the space is defined by a proximity border, and wherein movement of the speaker relative to the proximity border triggers at least one audio transition experience, wherein the audio transition experience includes at least one of:
a first experience wherein,
the speaker is outputting audio prior to the change in location and the one or more speakers is not outputting audio prior to the change in location,
in response to the speaker entering the proximity border, initiating audio output at the one or more speakers, and
maintaining the audio output at the one or more speakers in response to the speaker subsequently leaving the proximity border,
a second experience wherein,
the speaker is outputting audio prior to the change in location and the one or more speakers is not outputting audio prior to the change in location,
in response to the speaker entering the proximity border, initiating audio output at the one or more speakers, and
terminating the audio output at the one or more speakers in response to the speaker subsequently leaving the proximity border,
a third experience wherein,
the speaker is not outputting audio prior to the change in location and the one or more speakers is outputting audio prior to the change in location, and
in response to the speaker entering the proximity border, initiating audio output at the speaker,
a fourth experience wherein,
the speaker and the one or more speakers are outputting audio prior to the change in location, and
in response to the speaker entering the proximity border, re-assigning a role of at least one speaker, or
a fifth experience wherein,
the speaker and the one or more speakers are not outputting audio prior to the change in location, and
in response to the speaker entering the proximity border, assigning a role to the speaker configured to take effect in response to a subsequent trigger.

20. The speaker of claim 12, wherein determining the location of the speaker relative to the one or more other speakers is dictated by a proximity detection approach of a host speaker in a space.
